(19) United States
(12) Patent Application Publication
(10) Pub. No.: US 2003/0023910 A1
(43) Pub. Date: Jan. 30, 2003

(54) Method for monitoring and automatically correcting digital video quality by reverse frame prediction

(76) Inventors: Harley R. Myler, Orlando, FL (US); Michele Van Dyke-Lewis, Orlando, FL (US)

Correspondence Address: Supervisor, Patent Prosecution Services, PIPER MARBURY RUDNICK & WOLFE LLP, 1200 Nineteenth Street, N.W., Washington, DC, 20036-2412, US

(21) Appl. No.: 09/911,575

(22) Filed: Jul. 25, 2001

(51) Int. Cl. G06F 11/00

(52) U.S. Cl. 714/704

(57) ABSTRACT

A real-time video processing method for monitoring and correcting digital video quality by reverse frame prediction. Video frames within intercut sequences, defined by correlation analysis, are used for determining quality in real-time data streams by predicting whether a frame is of acceptable quality versus one or more of a set of frames of consistent quality. When quality anomalies are encountered, such as via comparison of each correlation coefficient to a range, and identification of the specific frame containing the degradation causing the coefficient correlation to fall within the identified range, such errors in frames are corrected by replacing, regenerating, or dropping the erroneous frames or portions thereof. The repaired video data stream is then sent onward to a receiving destination.

### BACKGROUND OF THE INVENTION

1. Field of the Invention

The field of the invention relates to real time video processing, and, more specifically, to measurement of digital video transmission quality and subsequent correction of degraded portions of the video or other anomalies in the video.

2. Background of the Technology

The future of image transmission—indeed, much of the present—is the streaming of digital data over high-speed channels. Streaming audio and video and other forms of multimedia technologies are becoming increasingly common on the Internet and in digital broadcast satellite television, and will take over most of the television broadcast industry in the next decade.

Broadcasters naturally want to build quality assurance into the product they send their customers. Such quality assurance is difficult, especially when video streams originate in a variety of different formats. Furthermore, various transmission channels have quite different degradation characteristics. Experts in video quality analysis and standardization communities have been and currently are grappling with this problem by assessing various methods of digital video quality assessment and correction in order to standardize quality measurement.

Video data from a source must often be rebroadcast immediately, with no time allotted for off-line processing to check image quality. What is needed is a way to detect and correct degraded video quality in real-time.

The need to transmit source reference data along with video data can preclude real-time processing and/or strain the available bandwidth. It requires special processing to insert and extract the reference data at the source and quality monitoring sites, respectively. What is needed is a way to detect degraded video quality without the need for additional reference data from the source.

Assessing the quality of a digital video stream does not help much if the stream is then resent in its degraded form. What is needed is a way to deliver a pure, non-degraded, digital video stream.

Specifically, a number of problems with the prior art exist in the regime of video quality analysis or measurement and the fundamental technique of video quality analysis with regard to digital video. One example in terms of digital video is what viewers often receive from a dish network, such as provided by Echostar Satellite of Littleton, Colorado, or DirecTV® of El Segundo, Calif. Digital video is also what viewers typically see when working with a computer to, for example, view Internet streaming and other video over the Internet. Other examples of digital video include Quicktime™ movies, supported by Apple Computer, Inc., of Cupertino, Calif., AVI movies in Windows, and video played by a Windows media player. Another important example of digital video is high definition television (HDTV). HDTV requires a substantially greater amount of bandwidth than analog television due to the high data volume of the image stream.

What viewers currently watch, in general, on standard home television sets is analog video. Even though the broadcast may be received as digital video, broadcasts are typically converted to analog for presentation on the television set. In the future, as HDTV becomes more widespread, viewers will view digital video on home televisions. Many viewers also currently view video on computers in a digital format.

A need has arisen and will continue to arise with regard to a fundamental method of analyzing video quality. This need arises typically as a result of a need to address some type of degradation in the video. For example, noise may have been introduced in a video stream that causes the original picture to be disturbed. There are various types of noises, and the particular type of noise can be critical because one form of digital video quality measurement involves examination of the specific type of degradation encountered.

Examples of various types of noise include the following. In one type of digital noise, the viewer sees “halos” around the heads of images of people. This type of noise is referred to as “mosquito noise.” Another type of noise is a motion compensation noise that often appears, for example, around the lips of images of people. With this type of noise, to the viewer, the lips appear to “quiver.” This “quivering” noise is noticeable even on current analog televisions when viewing HDTV broadcasts that have been converted to analog.

The analog conversion of such broadcasts, as well as the general transmittal of data for digital broadcasts for digital viewing, produces output that is greatly reduced in size from the original HDTV digital broadcast, in terms of the amount of data transferred. Typically, this reduction in data occurs as a result of compression of the data, such as occurs with a process called moving pictures expert group (MPEG) conversion or otherwise via lossy data compression schemes known in the art. The compression process selectively transfers data, reducing the transmittal of information among frames containing similar images, and thus greatly improving transmission speed. Generally, the data in common among these frames is transferred once, and the repetitive data for subsequent similar frames is not transferred again. Meanwhile, the changing data in the frames continues to be transmitted. Some of the noise results from the recombination of the continually transferred changing data and reused repetitive data.

For example, when a news broadcaster is speaking, the broadcaster's body may not move, but the lips and face may continuously change. The portions of the broadcaster's body, as well as the background behind the broadcaster on the set, which are not changing from frame to frame, are only transmitted once as a result of the compression routine. The continuously changing facial information is constantly transmitted. Because the facial information represents only a small portion of the screen being viewed, the amount of information transmitted from frame to frame is much smaller than would be required for transmission of the entire frame for each image. As a result, among other advantages, the transmission rate for such broadcasts is greatly increased from less use of bandwidth.

As can be seen from the above example, one type of the changing data that MPEG continuously identifies for transfer is data for motion occurring among frames, an important part of the transferred video. For video quality purposes, accurate detection of motion is important. Inaccuracies in identification of such motion, however, lead to subjective image quality degradation, such as lip “quivering” seen in such broadcasts.

In the prior art, one way to detect these problems is to have the original source data, such as the data as it is obtained by the camera and transferred onto tape when recorded, available in its pure and unadulterated form. To determine the quality of the transmission, this source data is compared algorthymically to the potentially degraded video that is transmitted or is to be transmitted. This method of video quality analysis, which remains a standard existing approach, is referred to as “the full reference method.” FIG. 1 illustrates the prior art full reference method. See also, for example, U.S. Pat. No. 5,596,364 to Wolf et al. There are many ways to compare in the full reference approach. The simplest and standard method is referred to as the peak signal to noise ratio (PSNR) method.

As shown in FIG. 1, from a video source 1, data is transmitted down a channel 2, until the data arrives at the video destination 3. In FIG. 1, as the data traverses the channel 2, something happens to the data, such as, in the example of HDTV, the data is reduced for use with standard definition television. In this HDTV example, at the video source 1, feature extraction 5 is performed, and at the video destination 3, a similar feature extraction 6 is performed. The two feature extractions 5, 6 are then compared 7 to produce a quality measure 8. In the case of PSNR, this comparison 7 is performed algorithmically. The data produced by the feature extractions 5, 6 are compared using a difference of means, such as pixel by pixel for each frame extracted. Typically, the quality measure 8 is expressed on a scale, such as 1-10.

In FIG. 1, channel 2 is sometimes referred to as a “hypothetical reference circuit,” which is a generic term for the channel through which data has passed or in which some other type of processing has occurred. Although the name suggests a “circuit,” the channel 2 is not limited to circuits alone, and may incorporate other devices or processes for transferring data, such as via digital satellite broadcasts, network data transmissions, whether wired or wireless, and other wireless transmissions.

There have also been a number of other attempts to create a robust full reference analyzer. One of the impediments to creating such analyzers is that a goal is for the analyzer to provide results that correspond well to a human opinion of the degraded video (referred to as “human visual perception” or HVP). Existing systems have attempted to reach the goal of matching HVP scores of the quality of the video. See, for example, U.S. Pat. No. 5,446,292 to Wolf, et al. However, success of known methods has varied. In tests sanctioned by the International Telecommunications Union (ITU) and run by their ad hoc Video Quality Experts Group (VQEG) that were completed in 2000, in which approximately 10 objective techniques or methods were evaluated, none of them performed statistically better than PSNR.

FIG. 2 illustrates current techniques for attempting to match HVP for video quality model generation. In these techniques, the perceptual model is open loop, in which the feedback mechanism is decoupled from the model generation. A perceptual model is theorized, tested, and adjusted until the model correlates to the outcomes determined by human observers. The models are then used in either a feature or differencing quality measurement.

Further, in current models, the adjustment process is performed ad hoc and offline with respect to the observation system, the observers themselves, as illustrated in FIG. 3. Features that have been related to HVP include Gabor transforms, Marr-Hildreth and Canny operators, fractal decompositions, and others. These measures are associated with the observer viewing static imagery. It would also be useful, however, to consider features that are related to motion estimation, such as Mean Absolute Difference (MAD) and others that attempt to model some aspect of pixels in motion from frame to frame.

One problem with the full reference method is that it requires the availability of the original source. The use of the original source, while working well in a laboratory, raises a number of problems. For example, if the original source data were to be available for comparison at the television set where the data is to be viewed, the viewer could simply watch the original source data, rather than the potentially degraded compressed data.

Thus, it is difficult to take a full reference system out of a laboratory. One way that the prior art attempts to overcome this problem is via two other techniques or methods, the first of which is referred to as the “reduced reference” method. An example of the reduced reference method of the prior art is shown in FIG. 4. See also, for example, U.S. Pat. No. 6,141,042 to Martinelli et al., U.S. Pat. No. 5,646,675 to Copriviza et al., and U.S. Pat. No. 5,818,520 to Janko et al.

As shown in FIG. 4, similarly to FIG. 1, data begins at a source 1, passes through a channel 2, and reaches a video destination 3. In the example shown in FIG. 4, the video source 1 is not available at the video destination 3. To address this problem, in the reduced reference method, feature extraction and coding 10 are performed at the video source 1. This feature extraction and coding 10 is an attempt to distill from the original video features or other aspects that relate to the level of quality of the video. The feature extraction and coding 10, such as, for example, with HDTV, produce a reduced set of data compared to the original video data. The resulting feature codes produced by the feature extraction and coding 10 are then added to the data stream 11. These feature codes are designed in such a way, or the channel is set up in such a way, that whatever happens to the original video, the feature codes remain unaffected. Such design can include providing a completely separate channel for the feature codes. A separate channel is used for this data, which is referred to as “metadata.”

For example, a very high speed channel can be provided for the video feed, such as a T-1 Internet Speed or a Direct Satellite Link (DSL) modem, and an audio modem, such as a modem at 56K baud to carry the channel of feature information. At the video destination 3, the features are extracted 6 from the destination video, which has presumably been degraded by the channel, and the feature codes extracted 6 from the original data stream 15 are compared 16 with the feature extraction 15, producing a quality measure 17.

One problem with the reduced reference approach is that an extra data channel is added, which has an associated cost. There is a continued need to solve the data quality analysis problem of transferred data without incurring the cost of using an extra channel.

The second technique is referred to as the “no reference” method. FIG. 5 presents an example of an existing “no reference” method for video quality analysis. As shown in FIG. 5, only at the video destination is feature extraction performed. This example of an existing no reference approach analyzes 20 for specific degradations in the data reaching the video destination 3 to produce the quality measure 21. For example, one problem that can occur with Internet streaming is what is referred to as a “blocking effect.” Blocking effects occur for very high speed video that is transmitted through a narrow bandwidth channel. What typically causes blocking effects is the use of discrete cosine transforms (DCT) performed on 8×8 pixel blocks in order to reduce the data prior to the transmission. Redundant information in the blocks is discarded from the data transfer to compress the data stream. However, if too much information is discarded in the compression scheme, in the resultant frame, the decoded frame appears to have a superimposed grid. The superimposed grid corresponds to the small blocks that are used for the DCT. Such grid effects are easy to detect using what are referred to as “blocking detectors.” See, for example, U.S. Pat. No. 5,745,169 to Murphy et al.

One problem with existing no reference methods is that these methods are able to detect only those specific problems that are programmed to be detected. There remains a continuing need to detect problems with video quality in general, rather than just those problems specifically programmed to be detected, like blocking effects.

Other attempts have been made to produce methods and systems to identify problems in video or digital frames. However, none of these existing methods and systems solves all of the problems identified above. For example, U.S. Pat. No. 5,969,753 to Robinson describes a method and system for comparing individual images of objects, such as products produced on an assembly line, for comparison to determine quality of the products. Each object is compared to a probabilistically determined range for object quality from averaging a number of images of the objects. U.S. Pat. No. 6,055,015 uses comparison among various received video signals to attempt to determine video degradation. U.S. Pat. No. 5,748,229 to Stoker describes a system and method for evaluating video fidelity by calculating information frame rate. U.S. Pat. No. 5,751,766 to Kletsky et al. evaluates video quality using secondary quality indicators from the receiver system. U.S. Pat. No. 6,011,868 to van den Branden et al. describes a bitstream quality analysis system in which parameters characterizing the bistream are extracted from the bitstream and analyzed to indicate video quality. U.S. Pat. No. 5,208,666 to Elkind et al. provides a method for error detection for digital television equipment in which one or more video data words are placed in active picture portions of the digital video for a digital test signal.

In general, there remains a problem in that many current video quality measurement techniques need additional data, sent by the source in parallel with the processed image data, as a reference source. For these methods, the quality assessment mechanism at the receiving end compares the reference source and the processed image to see whether the image has undergone significant degradation since it left the transmitting source. This requires increased bandwidth beyond what the image itself occupies. As a result, the full-reference technique is generally only useful in non-real-time scenarios of testing, such as occurs in the laboratory, and is not useful for such applications as broadcast video testing at the terminus of a digital video transmission.

Similarly, there is also a problem with a second group of existing techniques that uses a partial reference source for data comparison. Although these reduced reference methods operate on video at the terminus of a broadcast channel and do not require the original source data, these techniques still require extra bandwidth in order to convey the partial reference data.

Finally, there is a problem with a third group of existing techniques that use no reference source for data comparison, in that these techniques are limited to identifying specific quality problems for which they are designed.

### SUMMARY OF THE INVENTION

One advantage of the present invention is that it does not require reference source data to be transmitted along with the video data stream. Another advantage of the present invention is that it is suitable for online, real-time monitoring of digital video quality. Yet another advantage of the present invention is that it detects many artifacts in a single image, and is not confined to a single type of error.

Another advantage of the present invention is that it can be used for adaptive compression of signals with a variable bit rate. Yet another advantage of the present invention is that it measures quality independent of the source of the data stream and the type of image. Yet another advantage of the present invention is that it automatically corrects faulty video frames. Yet another advantage of the present invention is that it obviates the need for special processing by any source transmitting video to the present invention's location.

The present invention includes a method and system for monitoring and correcting digital video quality throughout a video stream by reverse frame prediction. In embodiments of the present invention, frames that are presumed or that are likely to be similar to one another are used to determine and correct quality in real-time data streams. In an embodiment of the present invention, such similar frames are identified by determining the frames within an intercut sequence. An intercut sequence is defined as the sequence between two cuts or between a cut and the beginning or the end of the video sequence. A cut occurs as a result of, for example, a camera angle change, a scene change within the video sequence, or the insertion into the video stream of a content separator, such as a blanking frame.

Practice of embodiments of the present invention include the following. Cuts, including blanking intervals, in a video sequence are identified, these cuts defining intercut sequences of frames, the intercut sequence being the sequences of frames between two cuts. Because the frames within an intercut sequence typically are similar, each of these frames produce a high correlation coefficient when algorithmically analyzed in comparison to other frames in the intercut sequence. In one embodiment of the present invention, cuts are identified via determination of a correlation coefficient for each adjacent pair of frames. The correlation coefficient is optionally normalized, and then compared to a baseline or range for the correlation coefficient to determine likelihood of the presence of a cut. Other methods are known in the art that are usable in conjunction with the present invention to identify intercut sequences. Such methods include, but are not limited to, use of metadata stream information.

In one embodiment, within each intercut sequence, each frame is compared to one or more other frames within the intercut sequence for analysis for degradation. Many analyses for comparing pairs of frames or groups of frames are known in the art and are usable in conjunction with the present invention to produce video quality metrics, which in turn are usable to indicate the likely presence or absence of one or more degraded frames. For example, such analyses include Gabor transforms, PSNR, Marr-Hildreth and Canny operators, fractal decompositions, and MAD analyses.

In one embodiment of the present invention, the method used for comparing groups of frames is that disclosed in applicants' U.S. patent application of Harley R. Myler et al. titled “METHOD FOR MEASURING AND ANALYZING DIGITAL VIDEO QUALITY,” having attorney docket number 9560-005-27, which is hereby incorporated by reference. The methods of that application that are usable with embodiments of the present invention incorporate a number of conversions and transformations of image information, as follows. A YCrCb frame sequence (YCrCb is component digital nomenclature for video, in which the Y component is luma, and CrCb (red and blue chroma) refers to color content of the image) is first converted using RGB (red, green, blue) conversion to an RGB frame sequence, which essentially recombines the color of the frame. The resulting RGB frame sequence is then converted using spherical coordinate transform (SCT) conversion to SCT images. Alternatively, the RGB conversion and the SCT conversion may be combined into a single function, such that the YCrCb frame sequence is converted directly to SCT images. A Gabor filter is applied to the SCT images to produce a Gabor Feature Set, and a statistics calculation is applied to the Gabor Feature Set to produce Gabor Feature Set statistics. The Gabor Feature Set statistics are produced for both the reference frame and the frame to be compared. Quality is computed for these Gabor Feature Set statistics producing a video quality measure. In addition, spectral decomposition of the frames may be performed for the Gabor Feature Set, rather than performing the statistics calculation, allowing graphical comparison of the Gabor feature set statistics for both the reference frame and the frame being compared.

Generally, the vast majority of the frames within the intercut sequence are assumed to be undegraded. Further, with the present invention, comparisons may be made among intercut sequences to further identify pairs of frames for which the video quality metrics indicate high correlation. As a result, after providing a method and system for identifying degraded frames, the present invention further provides a method and system for correcting such degradations. These corrections include removing the frames having degradations, replacing the frames having degradations, such as by requesting replacement frames from the video source, replacing degraded frames with other received frames with which the degraded frame would otherwise have a high correlation coefficient (e.g., another frame in the intercut sequence; highly correlating frames in other intercut sequences, if any), and replacing specific degraded portions of a degraded frame with corresponding undegraded portions of undegraded frames. Optionally, the degraded frame may also simply be left in place as unlikely to degrade video quality below a predetermined threshold (e.g., only a single frame in the intercut sequence is degraded).

In operation with some embodiments of the present invention, the analysis of the video stream resulting in identification of degraded frames may produce delays in transmission of the video stream. In one embodiment of the present invention, such delays in transmission of the video signal resulting from correcting degraded frames are masked by transmission of a blank message signal, such as a signal at a set-top box indicating that transmission problems are taking place.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 illustrates an example of a prior art full reference method;

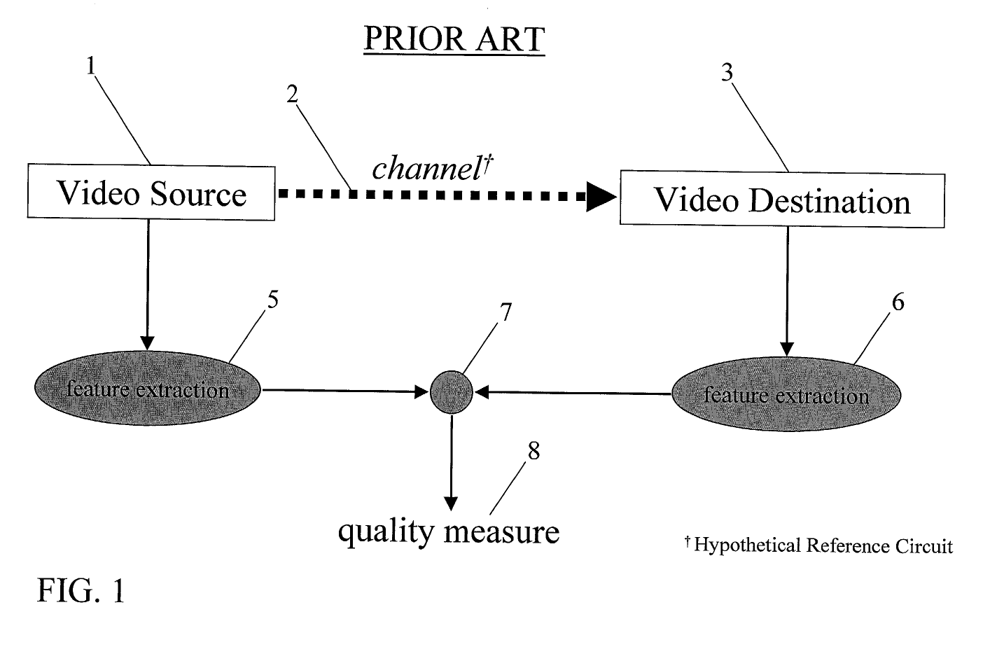

FIG. 2 presents an example of a current technique for attempting to match HVP for video quality model generation;

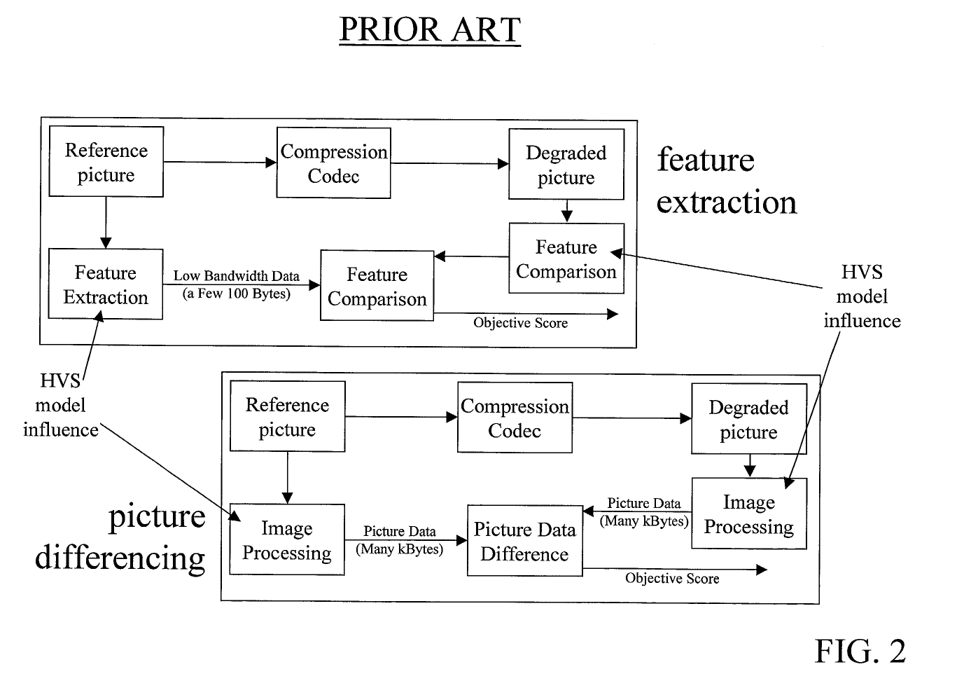

FIG. 3 illustrates that the adjustment process is performed ad hoc and offline with respect to the observation system in the prior art;

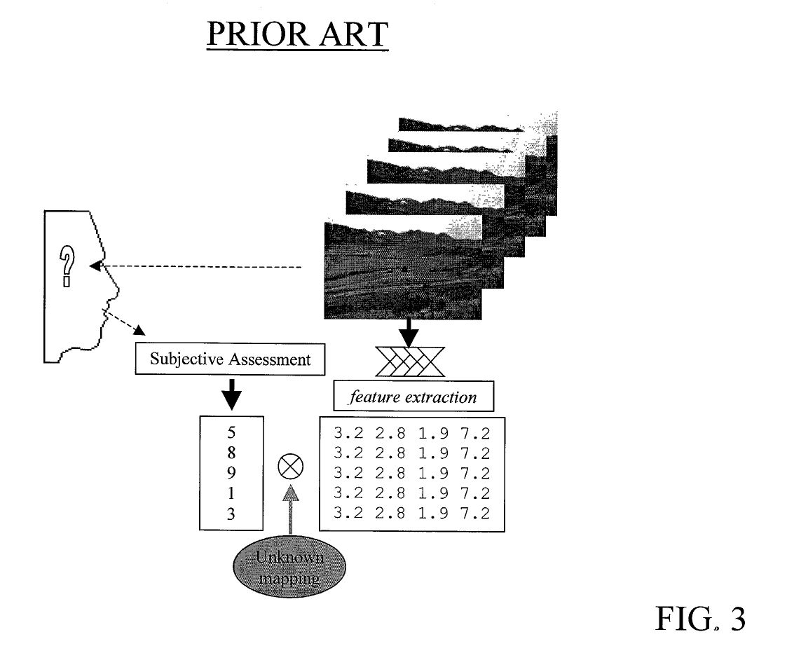

FIG. 4 provides an example of the reduced reference method of the prior art;

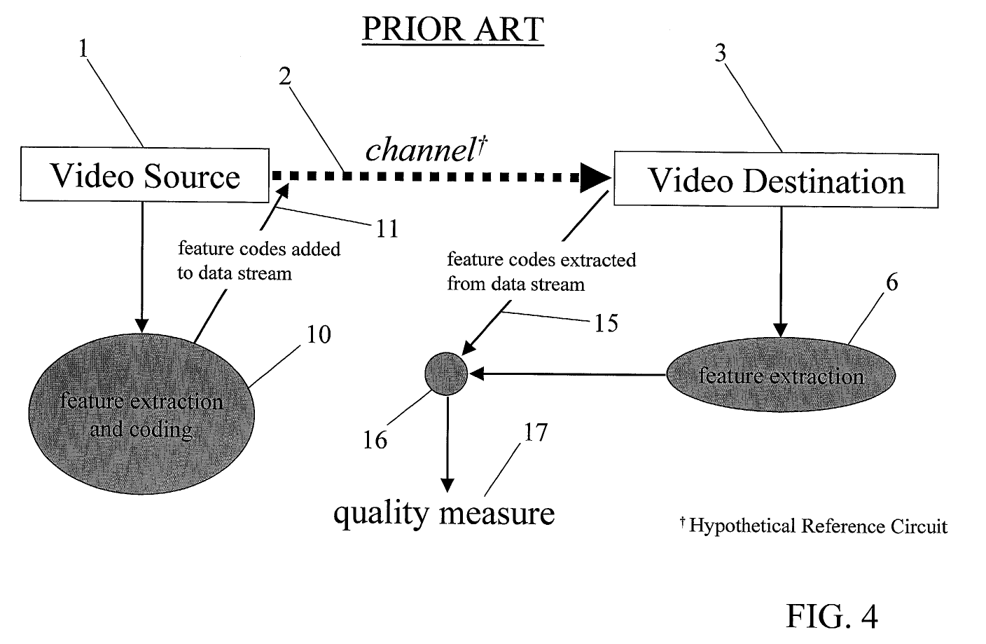

FIG. 5 shows an example of an existing “no reference” method for video quality analysis;

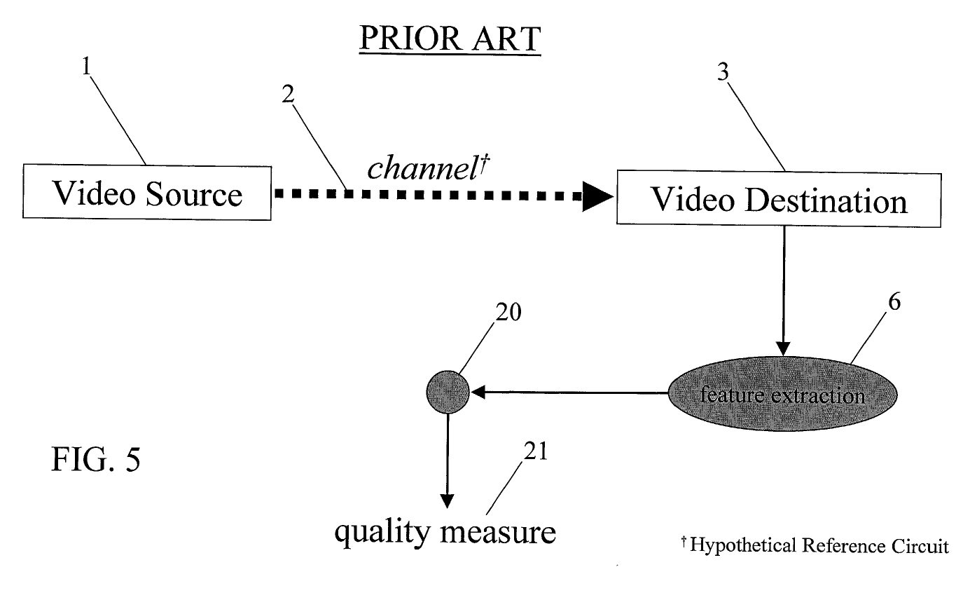

FIG. 6 presents an example of a blanking frame inserted in a video sequence in accordance with an embodiment of the present invention;

FIG. 7 presents a graphical summary of sample results among a sequence of frames, produced in accordance with an embodiment of the present invention, showing correlation coefficient results among the sequential frames;

FIG. 8 is an overview of one embodiment of the present invention, which uses reverse frame prediction to identify video quality problems;

FIG. 9 shows a pictogram of aspects of feature extraction between cuts in accordance with an embodiment of the present invention;

FIG. 10 provides information showing that interlaced video presents a potentially good model for quality analysis since each frame contains two fields, which are vertical half frames of the same image that are temporally separated;

FIG. 11 shows a typical sequence of video frames, making up a video transmission, as the sequence is transmitted down a communications channel, in accordance with an embodiment of the present invention; and

FIG. 12 is a flowchart showing an example method for monitoring and automatically correcting video anomalies, in accordance with one embodiment of the present invention.

### DETAILED DESCRIPTION

Embodiments of the present invention overcome the prior art for full reference methods at least in that these embodiments do not require use of the original video source. The present invention overcomes the problems with reduced reference methods in that no extra data channel is needed. In addition, the present invention overcomes the problems with existing no reference methods in that it is not limited to identified specific video quality problems, instead identifying all video quality problems.

In identifying and correcting such problems, the present invention utilizes the fact that transmitted video typically includes more undegraded data than degraded data. To identify portions of the video stream for which undegraded data is able or most likely to be used to correct degraded data, embodiments of the present invention first identify “intercut sequences,” which set the limits for portions of the video stream in which degraded and undegraded data are likely to be identified and easily correctable due to their likely similarity. Such intercut sequences include the frames between cuts in video. Such cuts occur, for example, when the camera view changes suddenly or when a blanking frame is inserted. A blanking frame is typically an all black frame that allows for a transition, such as to signal a point for breaking away from the video stream for insertion of a commercial.

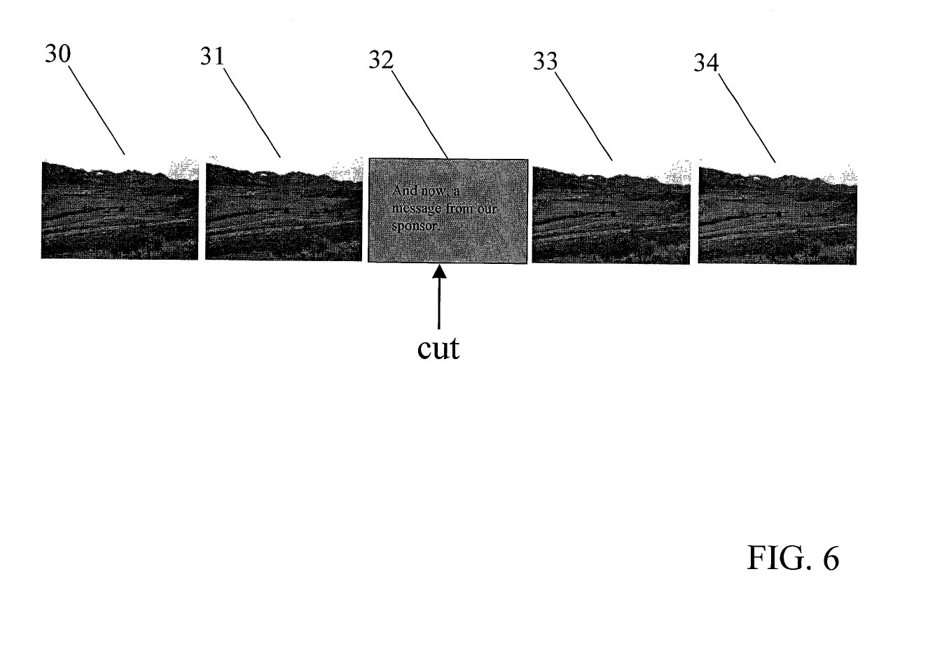

FIG. 6 presents an example of a blanking frame inserted in a video sequence. As shown in FIG. 6, a series of frames 30, 31, 32, 33, 34 making up a video sequence includes a blanking frame 32. In FIG. 6, each of the frames other than the blanking frame 32, including any two sequential frames other than the blanking frame 32, have a high correlation of data, especially from frame to frame. For example, high correlation from frame to frame for such sequential frames within the same intercut sequence is typically about 0.9 or higher in the scale described further below (normalized to unity). The reason for this high correlation among these frames is that they typically appear sequentially at high speed to provide a video presentation that is smooth, rather than containing a jerky motion, which would occur if each frame were not generally very similar to each subsequent or nearby frame within an intercut sequence. Conversely, with a camera cut between scenes, a low correlation typically occurs (e.g., 0.5 or less on the scale described below) from the last frame in the sequence for a first camera angle to the first frame in the next sequence.

By identifying the frames in an intercut sequence, a limited, or likely pool of candidate frames for comparison and from which to potentially obtain correction information is identified. Identifying the beginning of the intercut sequence potentially eases analysis, since sequential frames should be highly correlatable within each intercut sequence, assuming little presence of degradation in the video stream. Further, by restarting the video quality analysis technique and correction at the beginning of each intercut sequence, the likelihood is reduced that any errors resulting from this method and system are propagated beyond a single intercut sequence.

In an embodiment of the present invention, such cuts or blanking frames are detected using a correlation coefficient, which is computed using a discrete two dimensional correlation algorithm. This correlation coefficient reveals the presence of a cut in the video stream by comparing frames by portions or on a portion by portion basis, such as pixel by pixel. Identical or highly similar correlation, such as from pixel to pixel, among sequential frames indicates that no cut or blanking frame is identified. Conversely, low correlation reveals the likely presence of a cut or blanking frame. The frames between cuts constitute an intercut sequence. Once a cut is detected, the feature analysis process of the present invention is restarted. This reduces the chance of self induced errors being propagated for longer than an intercut sequence.

Cuts may also be identified using other methods and systems known in the art. Such other methods and systems include, for example, use of metadata stream information.

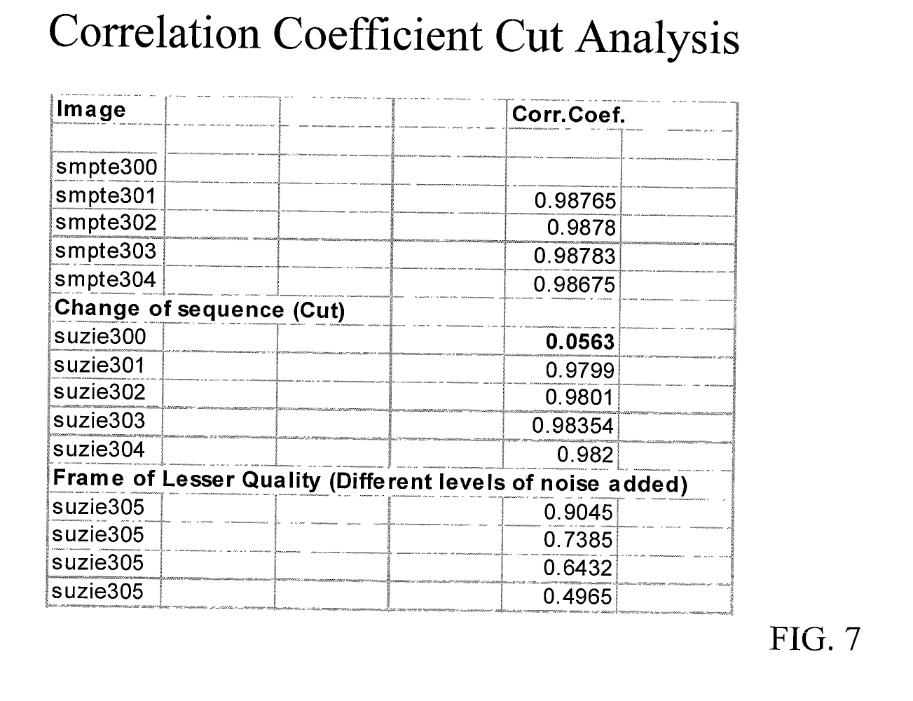

The graph shown in FIG. 7 presents sample results among a sequence of frames, produced in accordance with an embodiment of the present invention, showing correlation coefficient results among the sequential frames. As shown in FIG. 7, the change of sequence due to a cut at image “suzie300” produces a significantly lower correlation coefficient result compared to the previous sequence of frames “smpte300” through “smpte304.” Similarly, while not indicating the presence of a cut, lesser quality frames (e.g., frames with varying levels of noise), shown as the various “suzie305” frames, allow identification of varying quality problems, but do not signal the presence of a cut or blanking frame.

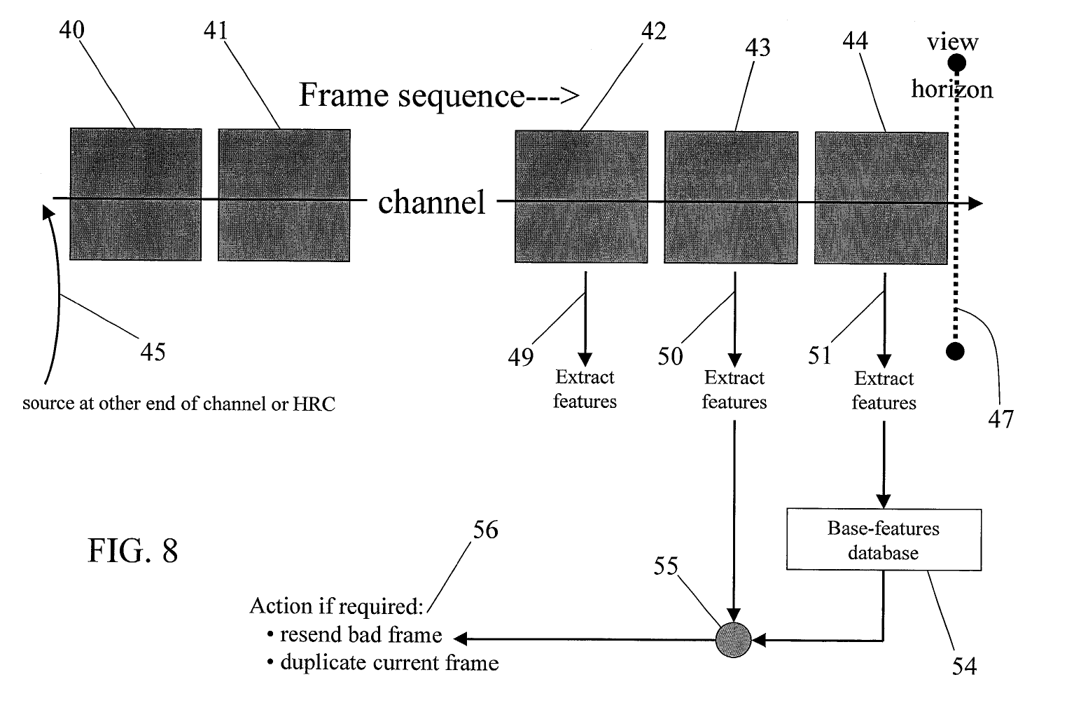

FIG. 8 presents an overview of one embodiment of the present invention, which uses reverse frame prediction to identify video quality problems. As shown in FIG. 8, a sequence of frames 40, 41, 42, 43, 44 is received at a viewing location from a source at the other end of the channel 45. As a view horizon 47 is approached, which is the moment that a viewer will observe a frame, feature extraction 49, 50, 51 occurs for the frames 42, 43, 44 that are approaching the view horizon 47, and it is possible to delay the view horizon 47.

At a view horizon 47 for the beginning of an intercut sequence, which occurs, for example, at the first frame following a camera cut, the present invention begins extracting features from the frames. Embodiments of the present invention take advantage of the assumption that the frames within the intercut sequence are robust, such that the video quality is high among these frames. High video quality is assumed within the intercut sequence because of the generally large number of frames available in situ (i.e., generally available in an intercut sequence) and because these frames are in a digital format, which decreases the likelihood of noise effects for most frames. The present invention stores the extracted features in a repository 54, such as a database, referred to in one embodiment as the “base features database,” or elsewhere, such as in volatile memory (e.g., random access memory or RAM).

The present invention compares the frames 55, such as frame by frame within the intercut sequence, by way of features within these frames, and action is required as necessary with respect to degraded frames, such as resending a bad frame or duplicating a good frame to replace a bad frame 56. The present invention, via use of a video quality analysis technique producing video quality metrics, allows identification of a frame or set of frames that deviates from, for example, a base quality level within the intercut sequence. Such identification of deviating frames (degraded frames, such as frames containing noise) occurs dynamically within every intercut sequence. Statistically, all the frames in an intercut sequence are assumed to be good frames, even though some frames within the intercut sequence can cause the video quality to be degraded. When a specific anomaly exists, such as blocking, it is detectable throughout the intercut sequence.

This approach of the present invention, which among other things, allows identification of specific features, including specific degraded portions within frames, also provides a basis for taking advantage of properties of the intercut sequence. One such property is the high correlation among frames within the intercut sequence. As a result, potentially, each intercut sequence includes a large number of correlated frames that are usable for purposes such as evaluating and correcting video quality problems: the large number of potentially undegraded frames provides a pool of features and other information potentially usable to correct video quality problems.

In embodiments of the present invention, the features extracted from various frames and used to correct possible video quality problems varies depending on the quality measure used. For example, one technique for quality analysis usable in conjunction with the present invention is the Gabor transform. The Gabor transform includes use of the following biologically motivated filter formulation:

$${p}_{k} ( x ) = \frac{{k}^{2}}{{σ}^{2}} exp ( - \frac{{k}^{2}}{2 {σ}^{2}} {x}^{2} ) ( exp ( ⅈ kx ) - exp ( - \frac{{σ}^{2}}{2} ) )$$

$${‖ {p}_{k} ( x ) ‖}^{2} \approx {k}^{2}$$

Another example quality analysis technique usable with the present invention is PSNR. The present invention, however, is not limited to any particular technique for quality analysis, and is usable with a wide range of quality analysis techniques, whether presently existing or yet to be determined.

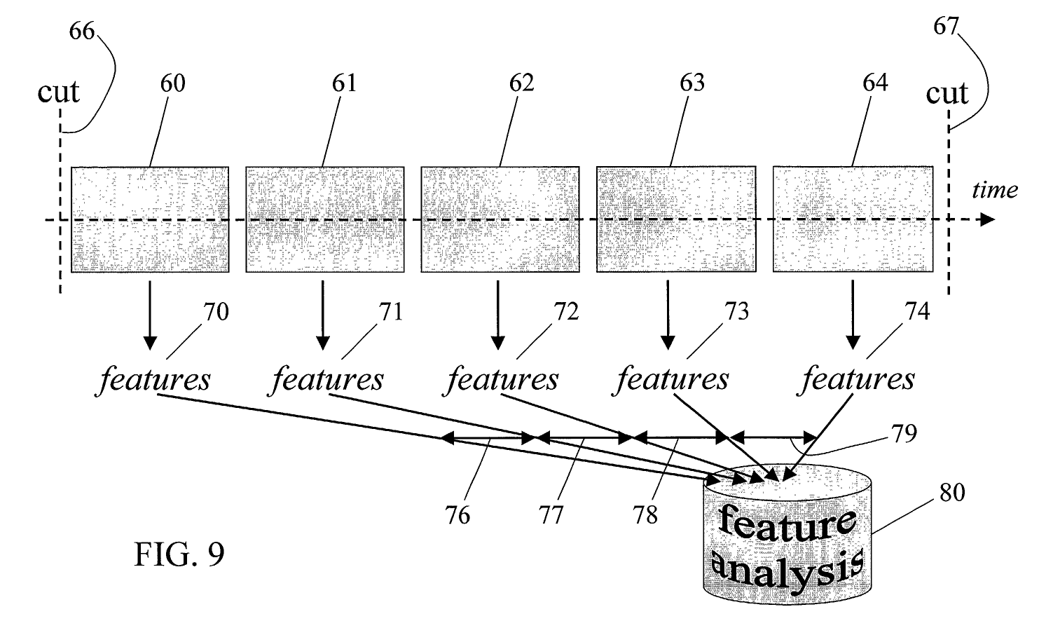

FIG. 9 presents a pictogram of aspects of feature extraction between cuts in accordance with an embodiment of the present invention. As shown in FIG. 9, an intercut sequence includes at least one, and typically a plurality of frames 60, 61, 62, 63, 64 between cuts 66, 67. Features of each frame 70, 71, 72, 73, 74 are compared from frame to frame 76, 77, 78, 79. In addition, in an embodiment of the present invention, each of the frame features 70, 71, 72, 73, 74 are compared amongst each other, not just to subsequent frames 76, 77, 78, 79 (e.g., frame feature 70 is compared to each of frame feature 71, frame feature 72, frame feature 73, and frame feature 74). The present invention takes advantage of the assumption that there are a collection of frames within the sequence of frames 60, 61, 62, 63, 64 that are undegraded. Further, the present invention takes advantage of the assumption that feature differences among the frames are identifiable, and that correction is performable on the degraded frames, or that, because such degraded frames are identifiable, an operator or other sender of the frames, may be notified to resend the degraded frames, or that a determination is makeable that the frames are passable despite their degradation. In accordance with embodiments of the present invention, the determination of response to degradation identification varies with the goals of the user of the system, in a process referred to as feature analysis 80. In embodiments of the present invention, feature analysis is accomplished via use of a processor, such as a personal computer (PC), a microcomputer, a minicomputer, a mainframe computer, or other device having a processor.

For example, if the present invention is operating in conjunction with a set-top box at an end user station, the provider of the video stream (e.g., broadcaster) may have a minimum level of quality degradation that the broadcaster prefers to maintain at the set-top box. If a delay due to correction of degradation occurs, the broadcaster can send a message to the set-top box saying, for example, “experiencing video difficulties” until the problem is corrected. In another example, if the number of degraded frames is small relative to the number sent, the degraded frames may simply be dropped without any noticeable effect for the viewer. The relative level of degraded frames that may be dropped is variable depending on the threshold of the broadcaster. In another example, if there is a large number of frames within an intercut sequence and a relatively small number of degraded frames, the degraded frames may be replicated using the good frames, which is a common technique used in Internet video streaming when a bad frame is encountered.

In an embodiment of the present invention, identification of the degradation varies, for example, from the pixel by pixel level to other sized areas, depending on the level of quality of degradation the user desires to identify, as well as the technique used for degradation identification.

One embodiment of the present invention uses as innercut sequence detection a correlation coefficient in which, for pairs of frames, the differences in the pixels are determined and the square of the differences is summed and then subtracted from unity to normalize the results with respect to unity. With this method, if, for example, there is very little difference between the pixels, then the sum of the squares approaches zero. If two frames are nearly identical, then the corresponding sum of the square of the differences approaches zero, and the correlation coefficient for the frames approaches unity—the higher the correlation coefficient, the more similar the two frames, while the lower the correlation coefficient, the less similar the frames. Generally, with this embodiment, within an intercut sequence, the correlation coefficient is typically around 0.9 with a drop down substantially below 0.9 indicating the presence of a cut.

Further, embodiments of the present invention allow use of information among intercut sequences. For example, if one innercut sequence has a high correlation with another innercut sequence, the present invention allows features to be extracted into the repository and carried to a higher correlated intercut sequence occurring later in the video stream. Once a cut is detected, in an embodiment of the present invention, feature analysis is restarted. This approach reduces the chance of self-induced errors propagating for more than an intercut sequence.

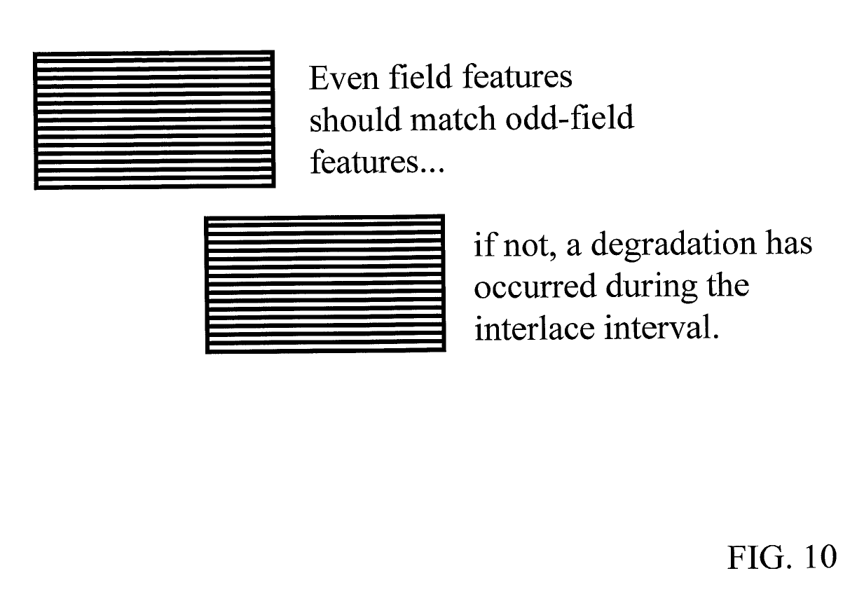

An embodiment of the present invention further includes a method and system for video quality analysis addressing use of interlaced video information. As shown in FIG. 10, interlaced video presents a potentially good model for quality analysis since each frame contains two fields, which are vertical half frames of the same scene (e.g., image) that are temporally separated. An embodiment of the present invention determines video quality based on determining the quality matching of the vertical half frames for sequential frames.

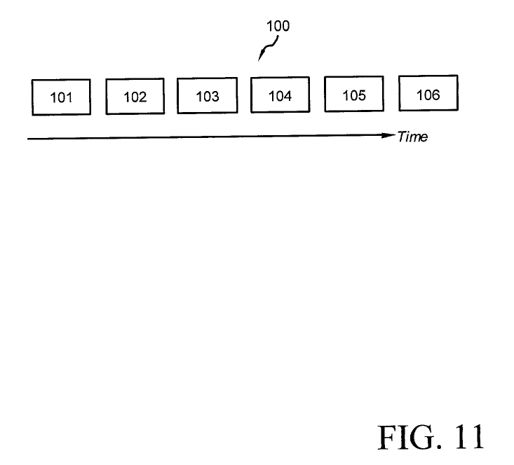

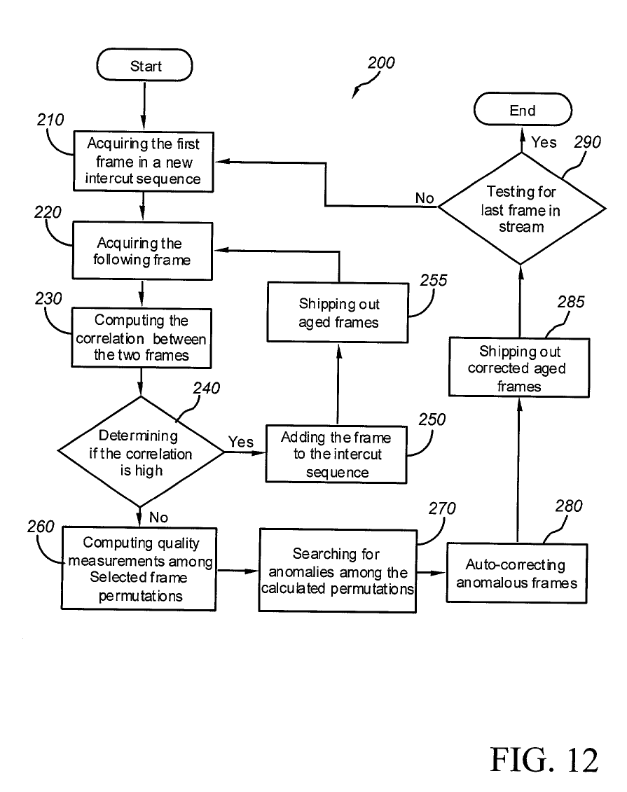

FIGS. 11 and 12 present overview information of operation of a method and system in accordance with one specific application of an embodiment of the present invention. FIG. 11 shows a typical sequence of video frames, making up a video transmission 100, as it is transmitted down a communications channel, in accordance with an embodiment of the present invention. FIG. 11 is used for reference in the description to follow. In this embodiment of the present invention, frames 101, 102, 103, 104, 105, 106 are received and stored while being inspected for anomalies. In an embodiment of the present invention, after a frame 101, 102, 103, 104, 105, or 106 has been corrected or verified to be accurate, it is displayed or sent on to its final destination. In this example in accordance with an embodiment of the present invention, frames that cannot be corrected are discarded and replaced with duplicates of prior frames.

FIG. 12 is a flowchart showing a method for monitoring and automatically correcting video anomalies for this example, in accordance with one embodiment of the present invention. The method includes a series of functions, as follows:

1. Acquiring the first frame in a new intercut sequence 210. In this function, the apparatus and software associated with the present invention acquire the first frame, frame 101, in a video transmission and store frame 101 in an available memory buffer. This is considered, by default, to be the first frame in the current intercut sequence.

2. Acquiring the following frame 220. In this function, the apparatus and software acquires the next video frame, frame 102, and stores frame 102 into an available memory buffer.

3. Computing the correlation between the two frames 230. In this function, the correlation is computed, such as by programmatic logic or by employment of an optical correlator, between the frame acquired in the previous action 220, and the previous frame of the current intercut sequence, using a well-known and efficient technique such as image subtraction or normalized correlation.

4. Determining if the correlation is high 240. In this function, programmatic logic passes control to the next action 250 if the correlation computed in the previous action 230 is high. Otherwise, the process proceeds to the following action 260.

5. Adding the frame to the intercut sequence 250. In this function, programmatic logic adds the frame most recently acquired in a previous action 220 to the current intercut sequence.

6. Shipping out aged frames 255. In this function, good frames that have been stored longer than a preset period are displayed or sent on to their final destination. In one embodiment of the present invention, no more than 30 frames would be stored prior to shipment.

7. Computing quality measurements among selected frame permutations 260. In this function, software algorithms compute the video quality between various pairs of frames in the current intercut sequence. Consider, for example, video transmission 100 of FIG. 11, in which a sequence of frames are identified 101, 102, 103, 104, 105, and 106. First, software algorithms compute the video quality between adjacent frames 101-102, 102-103, 103-104, 104-105, and 105-106. Then, these algorithms compute video quality between alternating frames 101-103, 102-104, 103-105, and 104-106. The algorithms also compute the video quality among other pairs of frames 101-104, 102-105, 103-106, 101-105, 101-106, and 102-106. The method used computes video quality using a full-reference or a no-reference technique. In one embodiment, the peak signal-to-noise ratio (PSNR) of the frame pairs is computed.

8. Searching for anomalies among the calculated permutations 270. In this function, software algorithms conduct a search for anomalies in the progression of quality measurements computed in the previous action 260. An embodiment of the present invention assumes that there is a gradual progression from the first frame in the intercut sequence to the last. Using the example from the previous funciton 260, a determination is made, such as that comparison of the frames 102-103 and frames 103-104 indicate quality measurements significantly poorer than the remaining measurements. This suggests that frame 103 has high degradation, since this frame is the common denominator between the two poor quality values. The software is able to compute the quality between frames 102-104 as an additional check.

9. Auto-correcting anomalous frames 280. In this function, replacing or regenerating the erroneous frames that resulted in the anomalies found in the previous action 270 corrects these anomalies. Continuing the example from the previous function 270, software algorithms optionally remove frame 103 and replace it with a copy of frame 102 or frame 104. In another example correction, algorithms calculate an interpolation between frames 102 and 104 and substitute the result for the degraded frame 103. The repaired frame is transmitted onward. In the case of a long sequence, a frame is able to be simply dropped.

10. Shipping out corrected aged frames 285. In this action, good frames or corrected frames that have been stored longer than a preset period are displayed or sent on to their final destination. In one embodiment of the present invention, no more than 30 frames are stored prior to shipment.

11. Testing for last frame in stream 290. In this function, programmatic logic tests to determine if the end of the video stream has been reached. For stored video, this is simply an end-of-file condition. For a received video stream, a simple timeout mechanism that detects no more arriving frames in a set interval indicates the end of the stream. If there are no more video frames in the stream, the process ends. Otherwise, the process returns to the first action 210.

Example embodiments of the present invention have now been described in accordance with the above advantages. It will be appreciated that these examples are merely illustrative of the invention. Many variations and modifications will be apparent to those skilled in the art.

What is claimed is:

1. A method for correcting errors in digital video for a received video stream without reference to a source video stream, the method comprising:
receiving a plurality of digital video frames, the plurality of digital video frames comprising a portion of the received video stream and having at least one intercut sequence; and
within one of the at least one intercut sequence(s),
applying a quality analysis technique to at least two of the plurality of digital video frames to produce at least one video quality metric;
determining whether each video quality metric indicates presence of a degraded frame; and
for each video quality metric indicating the presence of a degraded frame, identifying the degraded frame.

2. The method of claim 1, further comprising:
identifying each of the at least one intercut sequence(s) in the received plurality of digital video frames.

3. The method of claim 1, wherein applying a quality analysis technique to at least two of the plurality of digital video frames to produce at least one video quality measurement includes:
determining a peak signal to noise ratio.

4. The method of claim 1, wherein applying a quality analysis technique to at least two of the plurality of digital video frames to produce at least one video quality measurement includes:
applying a Gabor transform to the at least two of the plurality of digital video frames.

5. The method of claim 1, wherein applying a quality analysis technique to at least two of the plurality of digital video frames to produce at least one video quality measurement includes:
applying Marr-Hildreth and Canny operators to the at least two of the plurality of digital video frames.

6. The method of claim 1, wherein applying a quality analysis technique to at least two of the plurality of digital video frames to produce at least one video quality measurement includes:
applying fractal decomposition to the at least two of the plurality of digital video frames.

7. The method of claim 1, wherein applying a quality analysis technique to at least two of the plurality of digital video frames to produce at least one video quality measurement includes:
applying Mean Absolute Difference analysis to the at least two of the plurality of digital video frames.

8. The method of claim 1, wherein applying a quality analysis technique to at least two of the plurality of digital video frames to produce at least one video quality measurement includes:
determining a correlation coefficient for at least one pair of the at least two of the plurality of video frames.

9. The method of claim 1, wherein identifying the degraded frame includes:
applying a quality analysis technique to at least one of the at least two of the plurality of digital video frames and to at least a third one of the plurality of digital video frames.

10. The method of claim 1, further comprising:
correcting the degraded frame.

11. The method of claim 10, wherein correcting the degraded frame includes:
removing each of the degraded frame.

12. The method of claim 10, wherein correcting the degraded frame includes:
obtaining a replacement frame for the degraded frame.

13. The method of claim 12, wherein the replacement frame is obtained from the source video stream.

14. The method of claim 10, wherein correcting the degraded frame includes:
identifying a degraded portion of the degraded frame;
identifying at least one from the plurality of the digital video frames containing an undegraded portion corresponding to the degraded portion of the degraded frame; and
replacing the degraded portion of the degraded frame with the undegraded portion.

15. The method of claim 10, wherein correcting the degraded frame includes:
identifying a predetermined degradation in the degraded frame; and
correcting the predetermined degradation.

16. The method of claim 15, wherein the predetermined degradation includes one selected from a group consisting of a blocking effect, mosquito noise, and motion compensation noise.

17. The method of claim 2, wherein identifying the at least one intercut sequence includes:
identifying at least one cut in the received plurality of digital video frames.

18. The method of claim 17, wherein identifying at least one cut in the received plurality of digital video frames includes:
comparing at least a first one of the plurality of digital video frames to at least a second one of the plurality of digital video frames to produce at least one correlation coefficient;
comparing each of the at least one correlation coefficient to a predetermined range; and
for each of the at least one compared correlation coefficient falling outside the predetermined range, identifying at least one frame corresponding to a cut in the received plurality of digital video frames.

19. The method of claim 18, wherein each of the at least one correlation coefficient is normalized.

20. The method of claim 19, wherein each of the at least one correlation coefficient is normalized on a scale of 0 to 1.

21. The method of claim 20, wherein the predetermined range is approximately 0 to 0.9.

22. The method of claim 17, wherein the received video stream includes metadata stream information, and wherein identifying at least one cut in the received plurality of digital video frames includes:
analyzing the metadata stream information.

23. The method of claim 1, wherein the source video stream is processed to produce the received video stream.

24. The method of claim 23, wherein the source video stream is processed to produce the received video stream by passing the source video stream through a channel.

25. The method of claim 23, wherein the source video stream is processed to produce the receive video stream by applying a hypothetical reference circuit to the source video stream.

26. A system for correcting errors in digital video, the system comprising:
a source video stream;
a channel for operating on the source video stream to produce a received video stream;
a repository for storing information from the received video stream; and
a processor for analyzing the received video stream;
wherein a plurality of digital video frames are received by the processor, the plurality of digital video frames comprising a portion of the received video stream and having at least one intercut sequence;
wherein, within one of the at least one intercut video sequence(s), the processor applies a quality analysis technique to at least two of the plurality of digital video frames to produce at least one video quality metric;
wherein the processor determines whether each video quality metric indicates presence of a degraded frame; and
wherein, for each video quality metric indicating the presence of a degraded frame, the processor identifies at least one degraded frame.

27. The system of claim 26, wherein the channel comprises a circuit.

28. The system of claim 26, wherein the repository comprises a database.

29. A system for correcting errors in digital video for a received video stream without reference to a source video stream, the system comprising:
means for receiving a plurality of digital video frames, the plurality of digital video frames comprising a portion of the received video stream and having at least one intercut sequence; and
within one of the at least one intercut sequence(s),
means for applying a quality analysis technique to at least two of the plurality of digital video frames to produce at least one video quality metric;
means for determining whether each video quality metric indicates presence of a degraded frame; and
for each video quality metric indicating the presence of a degraded frame, means for identifying the degraded frame.
